(19) United States
(12) Patent Application Publication
(10) Pub. No.: US 2009/0044124 A1
(43) Pub. Date: Feb. 12, 2009

(54) METHOD, APPARATUS AND COMPUTER PROGRAM PRODUCT FOR FACILITATING DATA ENTRY USING AN OFFSET CONNECTION ELEMENT

(75) Inventor: Pekka Pihlaja, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION, Espoo (FI)

(21) Appl. No.: 11/834,310

(22) Filed: Aug. 6, 2007

(51) Int. Cl. G06G 3/00

(52) U.S. Cl. 715/733

(57) ABSTRACT

A method, apparatus and computer program product are provided for facilitating data entry into an electronic device via a touchscreen. As a user touches the touchscreen at a first location, a cursor may be displayed at that location. Because the cursor, as well as various items displayed on the touchscreen, are likely now obscured by the instrument used to touch the touchscreen, the user may sweep his or her finger away from the first location, at which point a pointer, or similar connection element, may be displayed between the cursor, which is maintained at the first location, and the second, new location of the instrument. The user may unlock the connection element and cursor, causing the connection element, and by extension the cursor, to begin moving with the instrument. The user may then move the cursor to its desired location by movement of the offset connection element.

### FIELD

Exemplary embodiments of the invention relate, generally, to electronic device touchscreens and, in particular, to a technique for facilitating the input of data into the electronic device via the touchscreen.

### BACKGROUND

As technology improves, electronic devices, such as cellular telephones, personal digital assistants (PDAs), pagers, and the like, appear to get smaller and smaller. With this decrease in size almost necessarily comes a decrease in the size of the display screens of those devices. At the same time, another advance in technology has been the use of these display screens as input devices for their corresponding electronic device. The display screens of many electronic devices are touch sensitive input devices, or touchscreens. However, because the display screens appear to be getting smaller over time, use of the display screen as a touch sensitive input device has become somewhat difficult. This is particularly true where it is intended that an individual use his or her finger to select a selectable item displayed on the touchscreen. As a user places his or her finger on a small item displayed on the touchscreen, the finger will likely occlude the item completely, as well as overlap some of the adjacent items displayed. Consequently, it is difficult if not impossible for the user to be certain which item he or she is selecting.

Several solutions have been proposed for facilitating data entry into relatively small touch sensitive input devices, or touchscreens. Each of these solutions, however, has at least one drawback. One solution is to dynamically magnify a selectable item on the touchscreen when the cursor, or other means of selecting the item, is within a certain proximity to the selectable item. According to this solution, a window displaying a magnified version of a selectable item opens directly on top of the selectable item when the cursor comes within proximity to the selectable item. As the cursor moves closer to the selectable item, the window size and magnification of the selectable item increase until the cursor reaches the magnified window. One drawback of this solution is that it may be difficult to implement where selectable items were scattered throughout a touchscreen, rather than in a single row or column. In particular, where the item the user wishes to select is surrounded by other selectable items, as the cursor moves closer to the intended item, one of the surrounding items would likely become magnified, thereby potentially making it difficult, if not impossible, to see and select the intended item.

Another solution, which may solve the above drawback to the first solution, is to only open the window displaying the magnified version of the selectable item when the user actuates a button. This solution, however, requires additional steps and may further make operating the electronic device to input data a two-handed operation, which is less than ideal. A third solution that has been proposed is to continuously display a window including a magnified view of what is under the window. In this solution, the window has edges that may not be well defined, wherein the magnification decreases smoothly at the margins of the window. According to this solution, however, the magnified window moves with the cursor and may cause the magnified view to appear unstable, restless and wobbly. This solution, therefore, would not facilitate data entry into the touchscreen.

In addition to the foregoing, each of the above solutions may have a further drawback in that the window displaying a magnified version of the selectable item appears directly on top of the selectable item. Where, for example, an individual is using his or her finger, and most commonly his or her thumb (e.g., where the individual is operating the electronic device with one hand) to select the item on the touchscreen, the magnification, and consequently the window, would have to be fairly large in order to make the selected item viewable from under the individual's finger. Given the above-referenced limited size of the display screen, having a large magnification window may be undesirable and may in fact be unfeasible in some circumstances. In addition, even if the magnification window is large enough to be viewable underneath the individual's finger, at least part of the selectable item may still be occluded at all times.

Further proposed solutions for facilitating data entry into relatively small touch sensitive input devices, or touchscreens that address the above drawback are to offset a magnified or unmagnified window above, below, to the left or to the right of the selectable item. Where magnified, this solution, as well as the above solutions, may have the additional drawback that magnifying parts of a graphical user interface generally requires vector graphics, which are not always available on electronic devices, such as cellular telephones; thus potentially causing these solutions to not be possible in some instances.

In addition, if the contents of the original view are magnified in the window, the amplitude of finger movements, including tremor, may be magnified as well. For example, if the contents of the window are magnified to twice their size (i.e., 2× magnification), any finger movement may cause the window contents to move with twice the speed. This may make the view in the window appear restless and hard to control. This problem could be solved by retaining the “gain” of movement (i.e., window content movement/finger movement) as a one-to-one ratio even if the view magnification is two-to-one. Unfortunately, this may create a new problem when the user needs to select (i.e., “paint”) a string of characters. In particular, in this situation, by the time the finger reaches the end of the string, the window and the pointer may only be halfway along the string. In other words, the finger and the pointer may no longer be pointing at the same item.

In addition, use of an offset window may have further drawbacks, whether the contents are magnified or not. In particular, as noted above, the size of the touchscreen may be rather small. As a result, there may not be sufficient room on the touchscreen to display an additional window in which items are displayed large enough to provide an improvement over the original display. In addition, the contents of the original touchscreen display are obscured not only by the user's finger, but also the offset window. As you increase the size of the offset window to further facilitate data entry, the more you obscure the original touchscreen display.

Yet another solution proposed has been to provide a set of crosshairs or a pointer just above the position where the user places his or her finger, which the user can use to aim. Several drawbacks may exist for this solution as well. In particular, one drawback may be that it forces the user to guess to some extent where to place his or her finger in order to select a certain item on the touchscreen, since he or she can no longer simply touch the screen at the location of that item. In addition, it may be very difficult to place a cursor or select an item at a location near one of the edges of the touchscreen. Finally, use of an offset pointer or crosshairs is likely not necessary in all situations (i.e., it would not be necessary where items displayed are large and well spaced apart). However, the above-described solution forces the user use the offset crosshairs in every instance.

A need, therefore, exists for a technique for facilitating data entry into a relatively small touch sensitive input device or touchscreen that overcomes at least the above-described drawbacks.

### BRIEF SUMMARY

In general, exemplary embodiments of the present invention provide an improvement by, among other things, providing a technique for facilitating data entry into an electronic device via a touch sensitive input device or touchscreen, wherein a connection element, such as a pointer, is displayed between a user's finger, or other instrument, and a cursor, such that the user can manipulate the position of the cursor by manipulating the connection element. In particular, according to one exemplary embodiment, a user may touch the touchscreen at a first location, at which location a cursor may be displayed. Because the cursor, as well as various items displayed on the touchscreen, are likely now obscured by the user's finger, or other instrument used to touch the touchscreen, according to one exemplary embodiment, the user may be able to sweep or move his or her finger away from the first location, at which point a connection element (e.g., a dashed or solid line) may be displayed between the cursor, which is maintained at the first location, and the second, new location of the user's finger, or other instrument. The user may then take some action necessary to unlock the connection element and cursor (e.g., moving his or her finger, or other instrument, in a direction substantially perpendicular to the connection element displayed), causing the connection element, and by extension the cursor, to begin moving with the user's finger, or other instrument. According to exemplary embodiments, the user may then move the cursor to its desired location by movement of the offset connection element.

In accordance with one aspect, a method is provided of facilitating data entry using an offset connection element, such as a pointer. In one exemplary embodiment, the method may include: (1) detecting a tactile input from a user at a first location on a touch sensitive input device; (2) causing a display of a cursor at the first location on the touch sensitive input device; (3) receiving an indication of a movement of the tactile input in a first direction to a second location on the touch sensitive input device; (4) causing, in response, a display of a connection element on the touch sensitive input device that extends at least partially between the first location and the second location; and (5) enabling the user to manipulate the display of the cursor through manipulation of the connection element.

In one exemplary embodiment, enabling the user to manipulate the display of the cursor through manipulation of the connection element may further comprise: receiving an indication of a movement of the tactile input in a second direction different from the first direction to a third location on the touch sensitive input device; translating the connection element displayed on the touch sensitive input device such that the connection element extends at least partially between the third location and a fourth location, wherein the angle and distance between the third and fourth locations are substantially the same as that between the first and second locations; and causing a display of the cursor at the fourth location.

According to another aspect, an apparatus is provided for facilitating data entry using an offset connection element. In one exemplary embodiment, the apparatus includes a processor configured to: (1) detect a tactile input from a user at a first location on a touch sensitive input device; (2) cause a display of a cursor at the first location on the touch sensitive input device; (3) receive an indication of a movement of the tactile input in a first direction to a second location on the touch sensitive input device; (4) cause, in response, a display of a connection element on the touch sensitive input device that extends at least partially between the first location and the second location; and (5) enable the user to manipulate the display of the cursor through manipulation of the connection element.

In accordance with yet another aspect, a computer program product is provided for facilitating data using an offset pointer. The computer program product contains at least one computer-readable storage medium having computer-readable program code portions stored therein. The computer-readable program code portions of one exemplary embodiment include: (1) a first executable portion for detecting a tactile input from a user at a first location on a touch sensitive input device; (2) a second executable portion for causing a display of a cursor at the first location on the touch sensitive input device; (3) a third executable portion for receiving an indication of a movement of the tactile input in a first direction to a second location on the touch sensitive input device; (4) a fourth executable portion for causing, in response, a display of a connection element on the touch sensitive input device that extends at least partially between the first location and the second location; and (5) a fifth executable portion for enabling the user to manipulate the display of the cursor through manipulation of the connection element.

According to another aspect, apparatus is provided for facilitating data entry using an offset pointer. In one exemplary embodiment the apparatus includes: (1) means for detecting a tactile input from a user at a first location on a touch sensitive input device; (2) means for causing a display of a cursor at the first location on the touch sensitive input device; (3) means for receiving an indication of a movement of the tactile input in a first direction to a second location on the touch sensitive input device; (4) means for causing, in response, a display of a connection element on the touch sensitive input device that extends at least partially between the first location and the second location; and (5) means for enabling the user to manipulate the display of the cursor through manipulation of the connection element.

### BRIEF DESCRIPTION OF THE SEVERAL VIEWS OF THE DRAWING(S)

Having thus described exemplary embodiments of the invention in general terms, reference will now be made to the accompanying drawings, which are not necessarily drawn to scale, and wherein:

FIG. 1 is a schematic block diagram of a mobile station capable of operating in accordance with an exemplary embodiment of the present invention;

FIG. 2 is a flow chart illustrating the operations which may be taken in order to facilitate data entry into an electronic device via a touch sensitive input device in accordance with exemplary embodiments of the present invention;

FIGS. 3A-3F provide screen shots of an electronic device touchscreen illustrating the technique for facilitating data entry by creating and enabling a user to manipulate a pointer, or similar connection element, in accordance with one exemplary embodiment of the present invention; and

FIGS. 4A-4F provide additional screen shots of an electronic device touchscreen illustrating the technique for facilitating data entry into an electronic device via a touch sensitive input device in accordance with another exemplary embodiment of the present invention.

### DETAILED DESCRIPTION

Exemplary embodiments of the present invention now will be described more fully hereinafter with reference to the accompanying drawings, in which some, but not all embodiments of the inventions are shown. Indeed, exemplary embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, exemplary embodiments of the present invention provide a method, apparatus and computer program product for facilitating data entry into an electronic device via a touch sensitive input device, wherein an offset connection element, such as a pointer, is displayed and can be manipulated in order to place a cursor at a desired location. As noted above, according to one exemplary embodiment, as a user places his or her finger, or other instrument, on the touchscreen at a first location, a cursor may be displayed at that first location. Where the items displayed on the touchscreen are large and/or well-spaced apart, the user may be able to easily see the cursor and at what location on the touchscreen the cursor is being placed. In this instance, the user may simply proceed as usual in order to select the item on which the cursor is placed and/or insert the cursor within the text document or message at its current location.

In contrast, where the items displayed on the touchscreen are close together, the cursor and the item(s) on or within which the cursor is placed are likely now obscured by the user's finger, or other instrument. As a result, according to one exemplary embodiment, the user is able to indicate that he or she would like to display an offset pointer, or similar connection element, to be used to direct the cursor. In particular, the user may sweep or move his or her finger away from the first location, while maintaining contact with the touchscreen, such that the items previously obscured by the user's finger, or other instrument, are now visible. In response to this movement, a pointer may be displayed that connects the cursor, which is maintained at the first location of the user's tactile input, and the new, second location of the user's tactile input (i.e., the location at which the user's finger or other instrument is currently touching the touchscreen). The pointer, or similar connection element, may, for example, comprise a dashed or solid line that extends at least partially between the cursor and the new location of the user's finger or other instrument.

If the user now determines that the cursor has not been placed at the right location, according to exemplary embodiments, he or she can unlock or detach the displayed pointer and attached cursor, such that the pointer, which will maintain its length and orientation, and cursor will move with the user's finger, or other instrument. In particular, in one exemplary embodiment, the user may again sweep or move his or her finger, or other instrument, in a predefined direction relative to the first movement (e.g., substantially perpendicular to the direction of the displayed pointer) to a third location, in order to detach the pointer and cursor. This movement will likewise cause the pointer to shift so that one end is now at the third location, at which the user's finger or other instrument is currently located, and the other end, to which the cursor is attached, is at a fourth location that is the same distance and angle from the third location as the first location was to the second (i.e., the pointer maintains is length and orientation as it moves with the user's finger or other instrument). The user is now able to see the cursor as it is being moved on the touchscreen.

### Electronic Device:

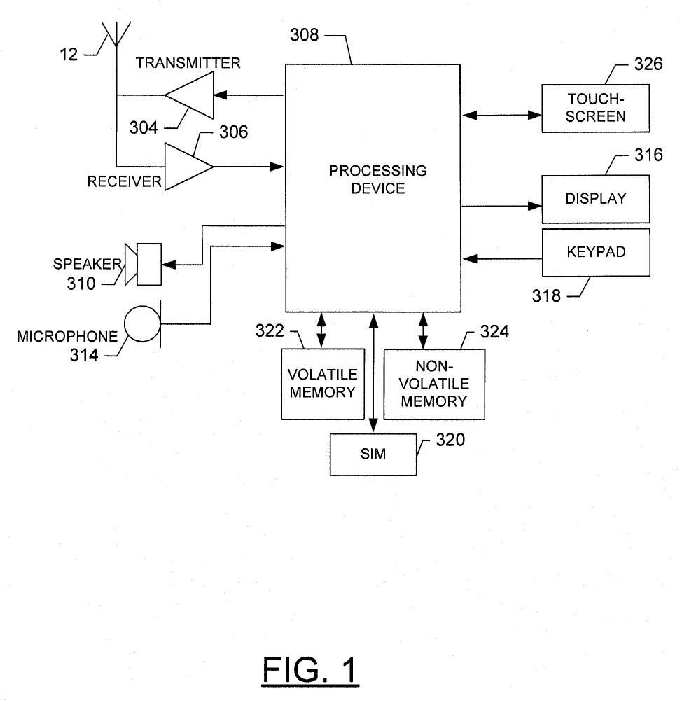

Reference is not made to FIG. 1, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

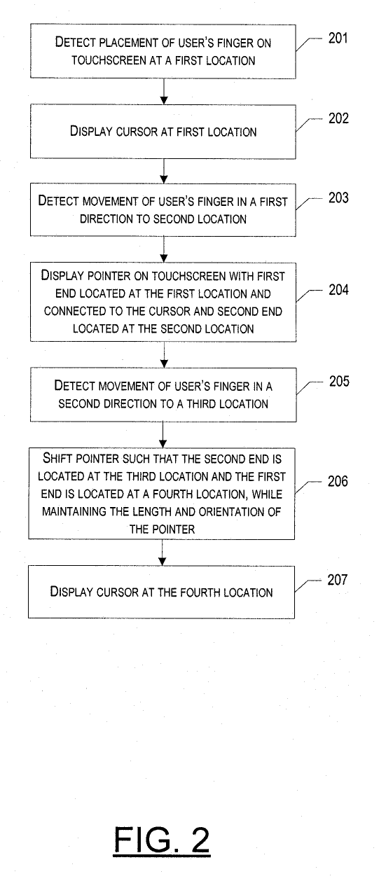

The mobile station includes various means for performing one or more functions in accordance with exemplary embodiments of the present invention, including those more particularly shown and described herein, such as a suitably programmed processor. It should be understood, however, that one or more of the entities may include alternative means for performing one or more like functions, without departing from the spirit and scope of the present invention. More particularly, for example, as shown in FIG. 2, in addition to an antenna 302, the mobile station 10 may include a transmitter 304, a receiver 306, and means, such as a processing device 308, e.g., a processor, controller or the like, that provides signals to and receives signals from the transmitter 304 and receiver 306, respectively. In one exemplary embodiment, the processing device 308, or other means, may be configured to facilitate data entry into the mobile station 10 in the manner described herein. In particular, according to one exemplary embodiment, the processing device 308 may be configured to detect a tactile input from a user at a first location on a touch sensitive input device of the mobile station 10 and to cause a cursor to be displayed at the first location on the touchscreen. The processing device 308, or other means, may likewise be configured to receive an indication of a movement of the tactile input in a first direction to a second location, and to cause, in response, a display of a connection element that extends at least partially between the first and second locations. The processing device 308 may thereafter be configured to enable the user to then manipulate the cursor through manipulation of the connection element.

The signals provided to and received from the transmitter 304 and receiver 306, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a microphone 314, a touch sensitive display or touchscreen 326, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory can also store content. The memory may, for example, store computer program code for an application and other computer programs. For example, as discussed in more detail below, in one embodiment, the memory may store computer program code for detecting a tactile input from a user at a first location on the touchscreen 326 of the mobile station 10 (e.g., when a user places his or her finger on the touchscreen 326), causing a display of a cursor at the first location on the touchscreen 326, receiving an indication of a movement of the tactile input in a first direction to a second location on the touchscreen 326 (e.g., when a user sweeps his or her finger away from the place where he or she originally touched the touchscreen 326), and causing in response, a display of a connection element, such as a pointer, on the touchscreen 326 that extends at least partially between the location where the user originally touched the touchscreen 326 (i.e., the first location) and the location where the user is currently touching the touchscreen 326 after sweeping his or her finger (i.e., the second location). The memory may further store computer program code for then enabling the user to manipulate the display of the cursor on the touchscreen 326 through manipulation of the pointer, or other connection element.

The method, apparatus and computer program product of exemplary embodiments of the present invention are primarily described in conjunction with mobile communications applications. It should be understood, however, that the method, apparatus and computer program product of embodiments of the present invention can be utilized in conjunction with a variety of other applications, both in the mobile communications industries and outside of the mobile communications industries. For example, the method, apparatus and computer program product of exemplary embodiments of the present invention can be utilized in conjunction with wireline and/or wireless network (e.g., Internet) applications.

### Method of Facilitating Data Entry Via a Touchscreen

Referring now to FIG. 2, which illustrates the operations which may be taken in accordance with exemplary embodiments of the present invention in order to facilitate data entry into an electronic device via a touch sensitive input device, or touchscreen. As shown, the process may begin when the electronic device and, more typically a processor or software executed by a processor of the electronic device, detects a tactile input on the electronic device touchscreen at a first location, for example, when a user places his or her finger on the touchscreen (Block 201). The electronic device may detect the tactile input and determine its location via any number of techniques that are known to those of ordinary skill in the art. For example, the touchscreen may comprise two layers that are held apart by spacers and have an electrical current running therebetween. When a user touches the touchscreen, the two layers may make contact causing a change in the electrical current at the point of contact. The electronic device may note the change of the electrical current, as well as the coordinates of the point of contact. Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

Returning to FIG. 2, once the tactile input has been detected, the electronic device and, more typically a processor or software executed by a processor of the electronic device may then cause, in Block 202, a cursor to be displayed on the touchscreen at the location of the tactile input (i.e., the first location). In other words, a cursor may be displayed on the touchscreen at the spot where the user touched the screen. Where, for example, the touchscreen is displaying a text document or message, the cursor will be placed relative to the letters displayed in the text document or message at the spot where the user touched the screen.

As discussed above, in many instances, the cursor displayed in Block 202 may be obscured by whatever instrument the user is using to touch the touchscreen (e.g., his or her finger), making it difficult for the user to determine what item he or she is about to select and/or at what point in a text document or message he or she is about to place a cursor. This is particularly true where the items displayed on the touchscreen are close together. If the user is unable to determine where on the touchscreen the cursor has been displayed, according to exemplary embodiments of the present invention, the user can move or sweep his or her finger (or other instrument used to create the tactical input, e.g., a stylus) in a first direction away from wherever he or she has touched the touchscreen (i.e., the first location) to a second location, which movement will be detected in Block 203 by a processor or software executed by a processor on the electronic device, and a connection element, such as a pointer may be displayed, in Block 204, that connects (or extends at least partially between) the first location where the user touched the touchscreen to the second location where the user is currently touching the touchscreen, while maintaining the cursor at the first location. While not shown, in one exemplary embodiment, in addition to displaying the pointer, or other connection element, the electronic device may also at this point magnify one or more items displayed on the touchscreen in order to provide the user with an even better view of the items displayed and where, in relation to those items, the cursor has been placed. Magnification may occur automatically or, in another exemplary embodiment, it may occur only when the second location of the tactile input (i.e., the location to which the user moves his or her finger or other instrument) is more than some predefined distance from the first location of the tactile input (i.e., the location where the user first touched the touchscreen). In one exemplary embodiment, magnification may be to some set level (e.g., 2 times the size of the original images). Alternatively, the level of magnification may be proportional to the length of the sweep, or the distance between the first location and the second location of the user's tactile input. Once the pointer has been displayed, the electronic device, and in particular a processor or software executed by a processor on the electronic device, may thereafter enable the user to manipulate the cursor through manipulation of the connection element or pointer.

In particular, according to one exemplary embodiment, in order to manipulate the pointer, and by extension the cursor, which is now maintained at the first end of the pointer, a user may first need to “unlock” the pointer from its current position. According to one exemplary embodiment, in order to do so, the user may move his or her finger, or other instrument, in a second direction that is different from the first direction (e.g., perpendicular to the displayed pointer) to a third location. This movement may be detected, in Block 205, by a processor or software executed by a processor on the electronic device, and be interpreted as an indication that the user would like to move the cursor. As one of ordinary skill in the art will recognize, other techniques may likewise be used for unlocking the pointer and, by extension the cursor, without departing from the spirit and scope of exemplary embodiments of the present invention. For example, they user may be required to momentarily lift his or her finger from the touchscreen, sweep/move his or her finger, or other instrument, some predefined distance, or actuate a soft or hard key, in order to unlock the pointer.

Once the pointer, or other connection element, and cursor have been unlocked or detached from their original position, the pointer and cursor may begin to move with the user's finger (i.e., the user can manipulate the cursor through manipulation of the pointer). In particular, continuing with the exemplary embodiment wherein unlocking the pointer involves the user moving his or her finger, or other instrument, in a second direction to a third location, in response to detecting this movement, the electronic device (i.e., the software executed by a processor on the electronic device) may shift the pointer, such that the second end moves to the third location (i.e., the new location of the user's finger or other instrument) and the first end, which is attached to the cursor, moves to a fourth location, while maintaining the length and orientation of the pointer. (Block 206). The cursor may then be displayed at the fourth location, in Block 207.

The above steps may thereafter be repeated in order to further manipulate the cursor. In other words, the user can continue to move his or her finger, or other instrument, in various directions around the touchscreen, and the pointer, having the cursor at one end and the user's finger or other instrument at the other end, will simultaneously move throughout the touchscreen. Once the user is able to place the cursor at the desired location, he or she can lift his or her finger, or apply more force to the touchscreen, in order to select the item on which the cursor is placed and/or to cause the cursor to be maintained at that location (e.g., within a text document or message).

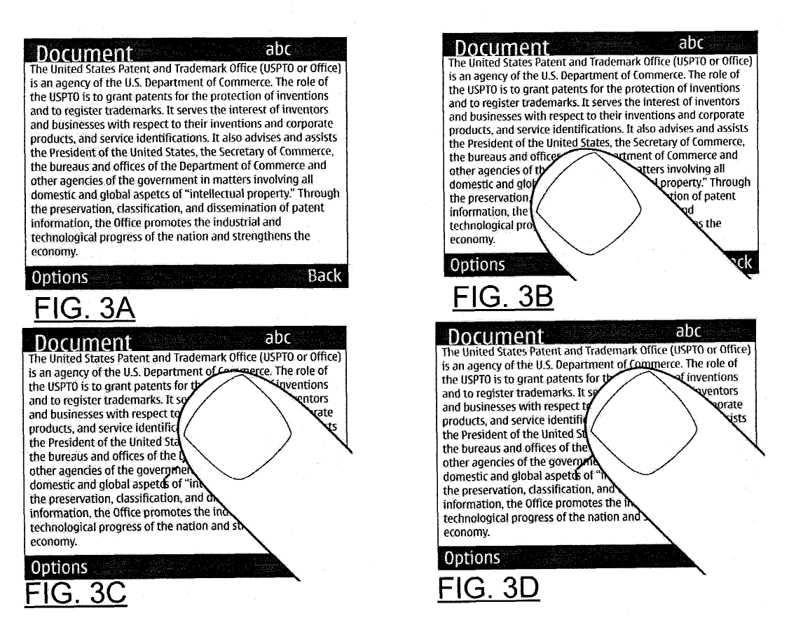

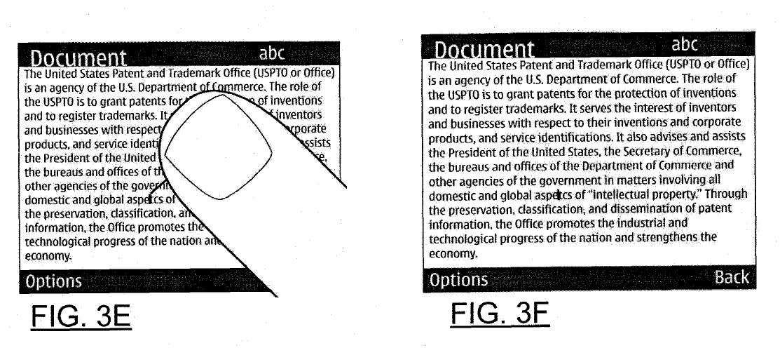

By way of example, FIGS. 3A-3F provide screen shots of a touchscreen of an electronic device illustrating placement of a cursor in a text document in accordance with one exemplary embodiment of the present invention. In particular, FIG. 3A illustrates a touchscreen displaying a text document including the misspelled word “aspetcs,” which the user in this exemplary embodiment would like to correct. In order to do so, the user may place his or her finger on the touchscreen, as shown in FIG. 3B, overtop of the position where the misspelled word is displayed. As shown, when the user does so, he or she is no longer able to see the word “aspetcs,” or many of the surrounding words, and, therefore, cannot tell whether he or she has placed the cursor on that word, let alone in the right place within that word (e.g., between the “e” and the “t”). In order to facilitate the user's placement of the cursor in the correct position, according to one exemplary embodiment shown in FIG. 3C, when the user moves or sweeps his or her finger, or other instrument, away from where it was originally placed (e.g., up and to the right, as shown), without removing his or her finger from the touchscreen, a pointer (shown as a dashed line) may be rendered on the display screen. As shown, the pointer may be between the cursor, which is now visible, and the new location of the user's finger. The user is now able to see that he or she has placed a cursor between the “c” and the “s” of the word “aspetcs.”

If, at this point, the user is unhappy with the placement of the cursor, for example because he or she would preferred to have had the cursor placed between the “e” and the “t” of the word “aspetcs,” according to one exemplary embodiment, the user may need to first unlock or detach the pointer from its current position. In one exemplary embodiment, in order to do so, the user may need to move his or her finger, or other instrument, again without lifting it from the touchscreen, in direction that is substantially perpendicular to the original movement (i.e., substantially perpendicular to the displayed pointer). By doing so, the pointer, and by extension the cursor, detaches from its initial position and begins moving with the user's finger, or other instrument. In one exemplary embodiment, this change in mode (i.e., from a fixed pointer and cursor to a movable pointer and cursor) may be delineated by changing the pointer from a dashed line to a solid line, as shown in FIG. 3D. The user is now able to move the cursor to the desired location, such as in between the “e” and “t,” as shown in FIG. 3E, by moving his or her finger and manipulating the pointer. Once the cursor has been placed at the desired location, the user may then lift his or her finger from the touchscreen, as shown in FIG. 3F, and the cursor will remain at that location relative to the items displayed on the touchscreen.

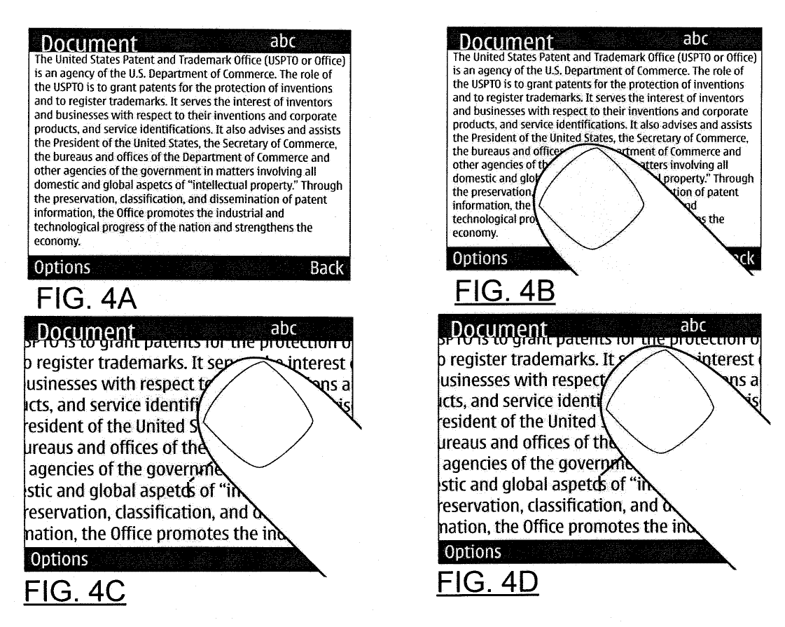

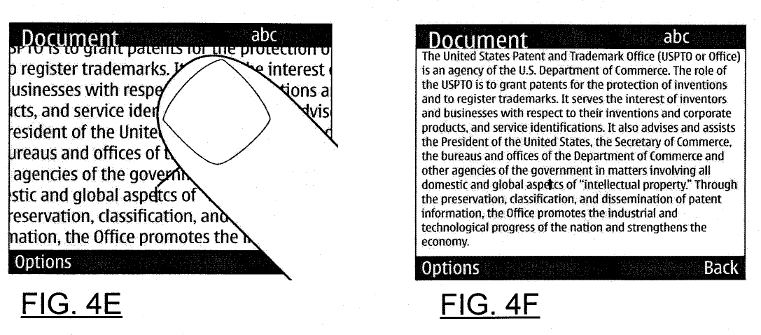

FIGS. 4A-4F provide screen shots of a touchscreen of an electronic device illustrating placement of a cursor in a text document in accordance with a similar exemplary embodiment. In this exemplary embodiment, the user again desires to place a cursor in between the “e” and “t” of a misspelled word (shown in FIG. 4A). He or she does so, as before, by placing his or her finger on the touchscreen, as shown in FIG. 4B, and obscuring the word and many of the surrounding words. In order to be able to see the location at which the cursor is being placed, the user may, as before and as shown in FIG. 4C, sweep his or her finger up and to the right causing a pointer to be displayed, while the cursor is maintained at its original location. This time, however, the electronic device (i.e., software executed by a processor operating on an electronic device) may also magnify the items displayed on the touchscreen in order to allow the user to more easily view the items displayed, as well as the placement of the cursor. Once the user has unlocked the pointer (as shown in FIG. 4D), moved the cursor to the correct position (as shown in FIG. 4E), and lifted his or her finger, or other instrument, the items displayed may return to their normal magnification, as shown in FIG. 4F.

### CONCLUSION

As described above and as will be appreciated by one skilled in the art, embodiments of the present invention may be configured as a method and apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these exemplary embodiments of the invention pertain having the benefit of the teachings presented in the foregoing descriptions and the associated drawings. For example, while the various embodiments have been described in conjunction with the use of a user's finger to select an item, other selection devices, such as a stylus, a pencil or the like, may be similarly employed. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
detecting a tactile input from a user at a first location on a touch sensitive input device;
causing a display of a cursor at the first location on the touch sensitive input device;
receiving an indication of a movement of the tactile input in a first direction to a second location on the touch sensitive input device;
causing, in response, a display of a connection element on the touch sensitive input device that extends at least partially between the first location and the second location; and
enabling the user to manipulate the display of the cursor through manipulation of the connection element.

2. The method of claim 1, wherein enabling the user to manipulate the display of the cursor further comprises:
receiving an indication of a movement of the tactile input in a second direction different from the first direction to a third location on the touch sensitive input device;
translating the connection element displayed on the touch sensitive input device such that the connection element extends at least partially between the third location and a fourth location, wherein the angle and distance between the third and fourth locations are substantially the same as that between the first and second locations; and
causing a display of the cursor at the fourth location.

3. The method of claim 1 further comprising:
magnifying one or more items displayed on the touch sensitive input device, upon receiving an indication of a movement of the tactile input in the first direction to the second location.

4. The method of claim 1 further comprising:
magnifying one or more items displayed on the touch sensitive input device, upon receiving an indication of a movement of the tactile input in the first direction to the second location, if the second location is greater than some predefined distance from the first location.

5. The method of claim 2, wherein enabling the user to manipulate the display of the cursor through manipulation of the connection element further comprises:
determining whether the second direction of movement of the tactile input is in a predefined direction relative to the first direction of movement, wherein the connection element is only translated and the cursor only displayed at the fourth location if the second direction is in the predefined direction.

6. An apparatus comprising:
a processor configured to:
detect a tactile input from a user at a first location on a touch sensitive input device;
cause a display of a cursor at the first location on the touch sensitive input device;
receive an indication of a movement of the tactile input in a first direction to a second location on the touch sensitive input device;
cause, in response, a display of a connection element on the touch sensitive input device that extends at least partially between the first location and the second location; and
enable the user to manipulate the display of the cursor through manipulation of the connection element.

7. The apparatus of claim 6, wherein in order to enable the user to manipulate the display of the cursor through manipulation of the connection, the processor is further configured to:
receive an indication of a movement of the tactile input in a second direction different from the first direction to a third location on the touch sensitive input device;
translate the connection element displayed on the touch sensitive input device such that the connection element extends at least partially between the third location and a fourth location, wherein the angle and distance between the third and fourth locations are substantially the same as that between the first and second locations; and
cause a display of the cursor at the fourth location.

8. The apparatus of claim 6, wherein the processor is further configured to:
magnify one or more items displayed on the touch sensitive input device, upon receiving an indication of a movement of the tactile input in the first direction to the second location.

9. The apparatus of claim 6, wherein the processor is further configured to:
magnify one or more items displayed on the touch sensitive input device, upon receiving an indication of a movement of the tactile input in the first direction to the second location, if the second location is greater than some predefined distance from the first location.

10. The apparatus of claim 7, wherein in order to enable the user to manipulate the display of the cursor through manipulation of the connection element, the processor is further configured to:
determine whether the second direction of movement of the tactile input is in a predefined direction relative to the first direction of movement, wherein the connection element is only translated and the cursor only displayed at the fourth location if the second direction is in the predefined direction.

11. A computer program product comprising at least one computer-readable storage medium having computer-readable program code portions stored therein, the computer-readable program code portions comprising:
a first executable portion for detecting a tactile input from a user at a first location on a touch sensitive input device;
a second executable portion for causing a display of a cursor at the first location on the touch sensitive input device;
a third executable portion for receiving an indication of a movement of the tactile input in a first direction to a second location on the touch sensitive input device;
a fourth executable portion for causing, in response, a display of a connection element on the touch sensitive input device that extends at least partially between the first location and the second location; and
a fifth executable portion for enabling the user to manipulate the display of the cursor through manipulation of the connection element.

12. The computer program product of claim 11, wherein the fifth executable portion is configured to:
receive an indication of a movement of the tactile input in a second direction different from the first direction to a third location on the touch sensitive input device;
translate the connection element displayed on the touch sensitive input device such that the connection element extends at least partially between the third location and a fourth location, wherein the angle and distance between the third and fourth locations are substantially the same as that between the first and second locations; and
cause a display of the cursor at the fourth location.

13. The computer program product of claim 11, wherein the computer-readable program code portions further comprise:
a sixth executable portion for magnifying one or more items displayed on the touch sensitive input device, upon receiving an indication of a movement of the tactile input in the first direction to the second location.

14. The computer program product of claim 11, wherein the computer-readable program code portions further comprise:
a sixth executable portion for magnifying one or more items displayed on the touch sensitive input device, upon receiving an indication of a movement of the tactile input in the first direction to the second location, if the second location is greater than some predefined distance from the first location.

15. The computer program product of claim 12, wherein the fifth executable portion is further configured to:
determine whether the second direction of movement of the tactile input is in a predefined direction relative to the first direction of movement, wherein the connection element is only translated and the cursor only displayed at the fourth location if the second direction is in the predefined direction.

16. An apparatus comprising:
means for detecting a tactile input from a user at a first location on a touch sensitive input device;
means for causing a display of a cursor at the first location on the touch sensitive input device;
means for receiving an indication of a movement of the tactile input in a first direction to a second location on the touch sensitive input device;
means for causing, in response, a display of a connection element on the touch sensitive input device that extends at least partially between the first location and the second location; and
means for enabling the user to manipulate the display of the cursor through manipulation of the connection element.

17. The apparatus of claim 16, wherein the means for enabling the user to manipulate the display of the cursor through manipulation of the connection element further comprises:
means for receiving an indication of a movement of the tactile input in a second direction different from the first direction to a third location on the touch sensitive input device;
means for translating the connection element displayed on the touch sensitive input device such that the connection element extends at least partially between the third location and a fourth location, wherein the angle and distance between the third and fourth locations are substantially the same as that between the first and second locations; and
means for causing a display of the cursor at the fourth location.

18. The apparatus of claim 16 further comprising:
means for magnifying one or more items displayed on the touch sensitive input device, upon receiving an indication of a movement of the tactile input in the first direction to the second location.

19. The apparatus of claim 16 further comprising:
means for magnifying one or more items displayed on the touch sensitive input device, upon receiving an indication of a movement of the tactile input in the first direction to the second location, if the second location is greater than some predefined distance from the first location.

20. The apparatus of claim 17, wherein the means for enabling the user to manipulate the display of the cursor through manipulation of the connection element further comprises:
means for determining whether the second direction of movement of the tactile input is in a predefined direction relative to the first direction of movement, wherein the connection element is only translated and the cursor only displayed at the fourth location if the second direction is in the predefined direction.
